(19) United States
(12) Patent Application Publication
(10) Pub. No.: US 2020/0311847 A1
(43) Pub. Date: Oct. 1, 2020

(54) MANAGEMENT OF VEHICLE AND HIRED DRIVER

(71) Applicant: Honda Motor Co., Ltd., Tokyo (JP)

(72) Inventors: Michael T. SAILER, Whittier, CA (US); Katie C. WALLACE, Long Beach, CA (US); Annika E. NORDLUND-SWENSON, Seattle, WA (US); Mariko K. SCHIMMEL, Rancho Palos Verdes, CA (US); Guilaume Leroux, Paris (FR)

(21) Appl. No.: 16/369,771

(22) Filed: Mar. 29, 2019

(51) Int. Cl. G06Q 50/30; G01C 21/34; G07C 5/00; B60W 30/18; B60W 40/08

(52) U.S. Cl. CPC G06Q 50/30; G01C 21/3438; G06Q 20/10; B60W 30/18; B60W 40/08; G07C 5/008

(57) ABSTRACT

The systems and methods provided herein are directed to a system for managing an arrangement between a vehicle owner and a non-owner driver. Between rides in which the driver operates the vehicle on behalf of the owner, the driver is authorized by the owner to take hired rides paid for by third parties. Limits on timing and distance are imposed on hired rides so that they conform to the owner's rides.

### BACKGROUND AND BRIEF DESCRIPTION

The advent of ride share services provides options for the use of valuable assets in order to recover portions of their value, in what is often referred to as the “sharing economy.” One discussion of value optimization is the potential for vehicles to be rented to third parties when they are not being used by their owners.

The present disclosure describes methods and apparatus for a system by which a driver can provide a chauffeur service for a vehicle owner, and then use the owner's vehicle to provide a ride share service to third parties.

According to aspects of an exemplary embodiment, a computer-implemented method includes coordinating with a driver to operate a vehicle having an owner separate from the driver, the operation of the vehicle including first and second rides requested by the owner; providing authorization for the driver to operate the vehicle for hire by one or more third parties during a time interval between the first and second rides; and limiting the driver's authorization such that the driver is not authorized to operate the vehicle for hire by one or more third parties during the first or second rides.

In some embodiments, the operation of the vehicle can further include a third ride requested by the owner. The method can also include providing authorization for the driver to operate the vehicle for hire by one or more third parties during a time interval between the second and third rides.

In some embodiments, the authorization for the driver to operate the vehicle for hire can be geographically limited based on the owner's requested rides.

In some embodiments, the method can include allocating revenue from third party hire of the vehicle to both the driver and the owner.

In some embodiments, the method can also include, during the time interval between the first and second rides, receiving a request from the owner for a third ride to occur during the time interval; in response to receiving the request for the third ride, restricting the driver's authorization such that the driver is not authorized to operate the vehicle for a third party until the driver has operated the vehicle to carry out the third ride; and upon completion of the third ride, restoring the driver's authorization for a remainder portion of the time interval. In some aspects, if the driver is presently carrying out a ride for a third party when the request for the third ride is received, restricting the driver's authorization does not affect the present ride.

In some embodiments, the method includes receiving a request for a third party ride during the time interval; and automatically rejecting the request, based on determining that, after carrying out the third party ride, the vehicle would not be able to arrive in time to carry out the second ride.

In some embodiments, the second ride has a destination that is the same as an origin point of the first ride, such that passengers of both the first and second ride return to where they began.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES can be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a timeline describing rides driven by a non-owner driver in accordance with one aspect of the present disclosure;

FIG. 2 is a flowchart describing a process for managing rides taken by a non-owner

FIG. 3 is an illustration of a status screen for a vehicle owner in accordance with one aspect of the present disclosure;

FIG. 4 is an illustration of a navigation screen in accordance with one aspect of the present disclosure; and

FIG. 5 is an illustration of driver selection screen in accordance with one aspect of the present disclosure.

### DESCRIPTION OF THE DISCLOSURE

The description set forth below in connection with the appended drawings is intended as a description of exemplary embodiments of the disclosure and is not intended to represent the only forms in which the present disclosure can be constructed and/or utilized. The description sets forth the functions and the sequence of blocks for constructing and operating the disclosure in connection with the illustrated embodiments. It is to be understood, however, that the same or equivalent functions and sequences can be accomplished by different embodiments that are also intended to be encompassed within the spirit and scope of this disclosure.

Generally described, the systems and methods herein are directed to managing an arrangement for a vehicle to be driven by a non-owner, both for hire and for benefit of the owner.

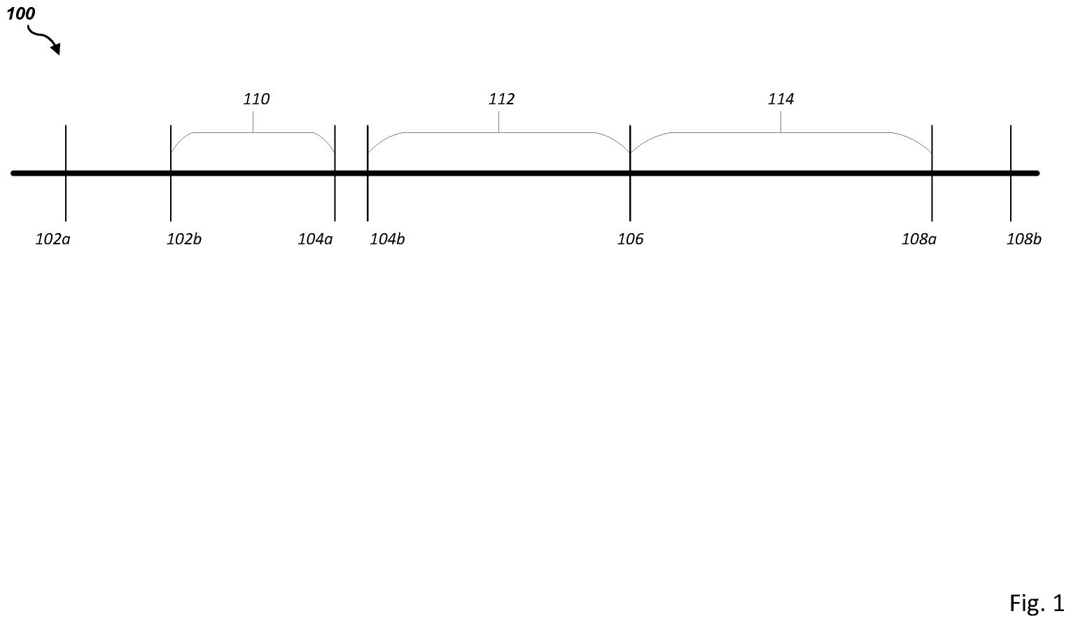

FIG. 1 is a timeline 100 illustrating a day for a hired driver under the arrangements described in this disclosure. At a first time 102a, the driver arrives at the location of the vehicle and picks up one or more passengers associated with the vehicle owner. The owner-associated passenger or passengers are dropped off at time 102b, at which point the driver and vehicle are hired out to third parties. Between times 104a and 104b, the driver makes another pick-up and drop-off for the vehicle owner, and then is for-hire again. Time 106 represents a “brief stop” for the owner, such as quickly dropping by the owner's location to allow the owner to access trunk space in the vehicle. The driver is then for hire again until time 108a, and returns any passengers and the vehicle to a location at time 108b.

In this example, the intervals 110, 112, and 114 represent time intervals during which the driver earns revenue by taking paying passengers. Although this may differ in varying implementations, in this example, the intervals of time for which the driver is hired by paying passengers total a large majority of the time, with only a small part of the time being set aside for owner-related trips.

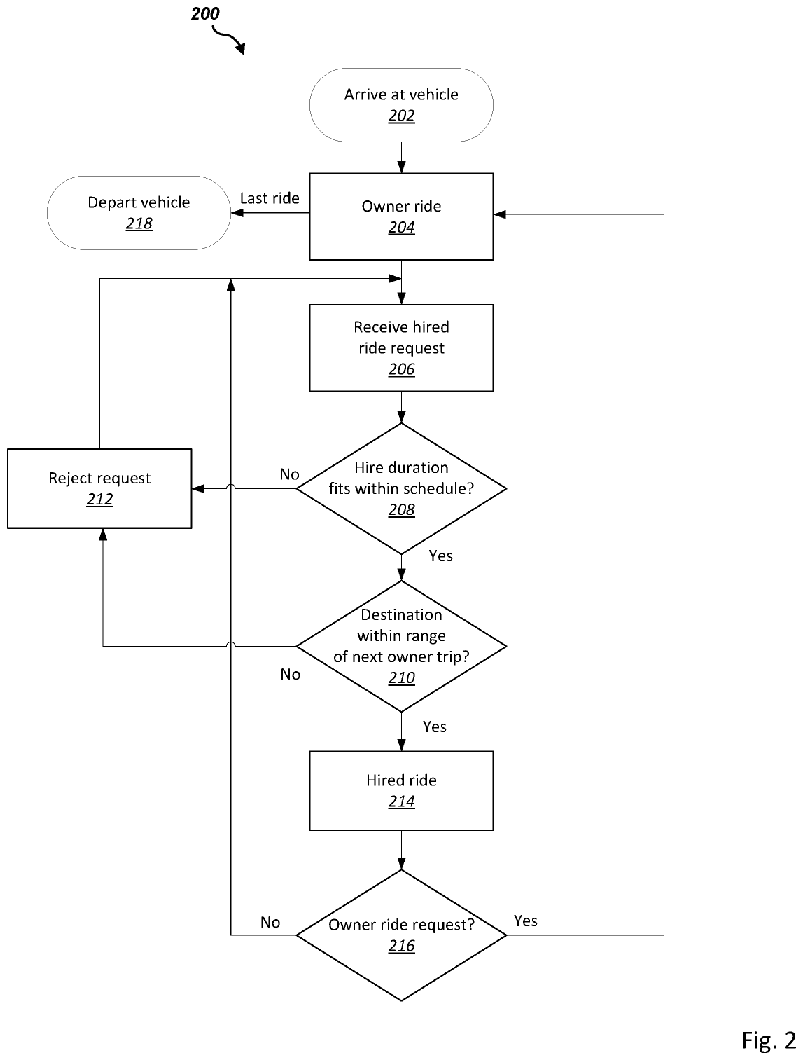

FIG. 2 is a flowchart 200 illustrating a process for a driver using an owner's vehicle as described. Here, the arrangement begins when the driver arrives at the vehicle (step 202). In some implementations, the driver may arrive using another mode of transportation (such as, for example, a collapsible scooter that is known in the art to be used by hired drivers to travel to where the vehicle is).

The driver begins by transporting the owner and/or persons associated with the owner (such as the owner's friends or family) to a planned destination (step 204). In some implementations, this owner ride, and subsequent owner rides, are pre-planned and known to the driver before the driver accepts the arrangement. In that way, the driver has the ability to assess whether the location of the trips and the time allotted are worth the services being asked in terms of expected revenue.

After finishing the owner's ride, the driver can provide services to third parties to earn revenue in a ride hire model. When the system receives a request for a hired ride (step 206), it checks to see if the hired ride fits within the existing schedule of planned owner ride (step 208), and whether the destination of the hired ride would leave the vehicle within range of the next owner ride (step 210). Each of these requirements may be significantly more relaxed while the next planned owner ride is well in the future, but may become very restricted as the time of the owner's next ride approaches. The ride request is rejected (step 212) if either requirement is not met, and other ride requests may then be considered.

If the hired ride fits the requirements, then the driver may carry out the hired ride (step 214), thus earning revenue for the ride. In some implementations, some of the amount paid by the hiring passenger is used to defray costs associated with the system managing the arrangements as described. Furthermore, in some implementations, the vehicle owner also receives a portion of the revenue generated, or receives a rental fee for use of the vehicle. Alternatively, the owner may pay a fee to the driver for the owner's rides, in addition to the driver using the vehicle for hired rides. The particulars of the arrangement may depend on the relative value of the use of the vehicle and of the driver's services, and may depend, for example, on the relative amount of time that the driver is required to spend on owner rides versus hired rides.

Upon completion of a hired ride, the system checks to determine if an owner ride request is currently active (step 216). In some implementations, an owner can make requests for additional rides during the day, and these requests supersede the taking on of additional hired ride requests. After dropping off the owner's passengers, the driver can then take on additional fares.

At the completion of the day's arrangement, a final owner ride (“last ride” branch of step 204) ends with the vehicle at a drop-off location. The driver then departs the vehicle (218), taking an alternate form of transportation away from the last ride's destination, and ending the arrangement.

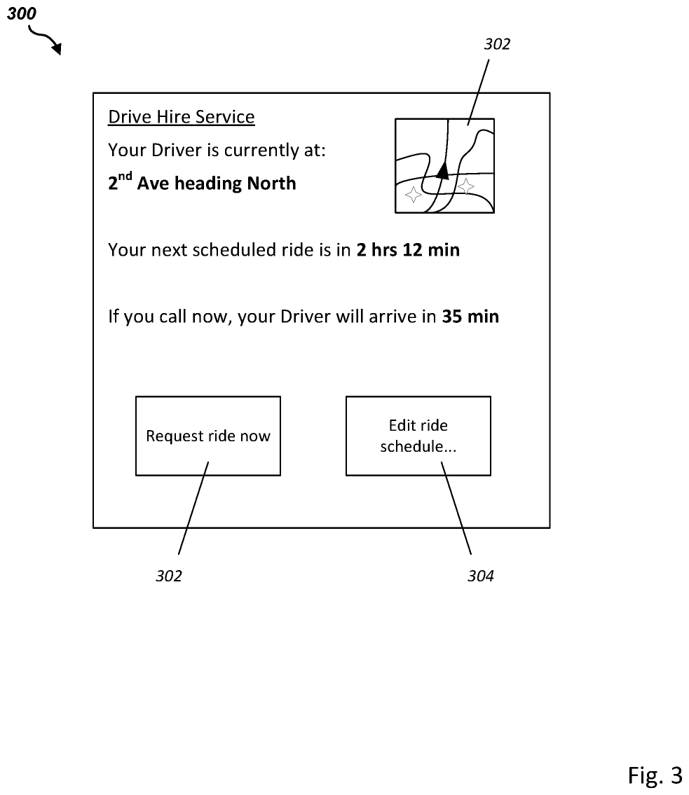

FIG. 3 illustrates a status window 300 provided to a vehicle owner during the arrangement. An inset map 302 shows a current location of the vehicle, which may be monitored through the driver's mobile device or through sensors associated with the vehicle itself. As shown, the status window 300 indicates when the driver is next scheduled to provide an owner ride. Additionally, an estimated time is provided should the owner request a ride.

The ability to request an unplanned ride may be permitted in some implementations of the disclosure. Alternatively, the terms of the agreement may limit the ability of the owner to request a ride outside of time, location, or frequency limits that were determined before the arrangement started. In some implementations, a ride owner may be able to request additional rides outside of those planned, but only by providing a supplemental fee or additional consideration to the driver (such as a longer overall arrangement for generating revenue).

The estimated time for requesting an unplanned ride may be calculated based on the estimated time of arrival for any hired ride the driver has already undertaken, plus the estimated amount of time to travel from the hired ride's destination to the owner's location. For example, if the driver is still 18 minutes away from the destination point of a hired ride that is 15 minutes from the location of the owner, the owner may be given an estimated arrival time of 35 minutes.

The driver can request a ride as soon as possible by selecting that button 302, or may select another button to edit the planned timing of future rides. In some implementations, the driver may have more freedom to edit the timing and specifics of rides that are farther in the future.

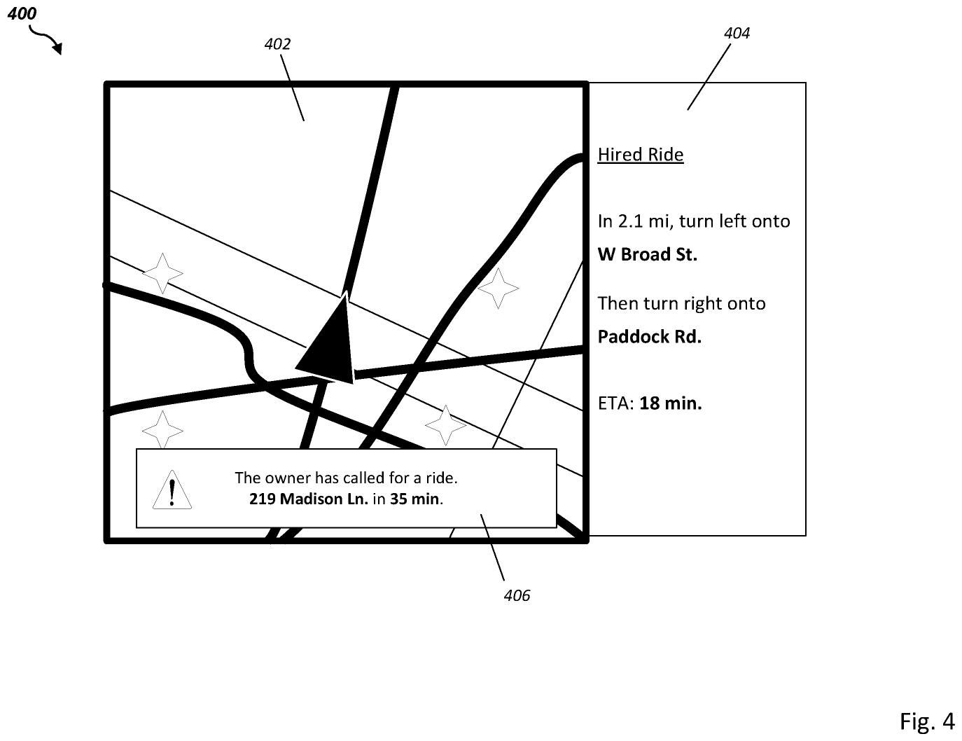

FIG. 4 shows a driver navigation screen 400 that includes both map 402 and direction 404 windows to guide the driver on a hired ride. Directions and an estimated time of arrival are shown.

In response to the owner requesting a previously unplanned ride, an alert window 406 appears on the screen 400 informing the driver of the owner ride's location and estimated time. When the owner calls upon a ride within the agreed-upon terms of the arrangement, the system no longer allows the driver to accept other hired rides until the driver has carried out the owner ride.

Certain implementations of the system may match potential drivers with potential vehicle owners based on a variety of factors, including the relative location of the parties and their availabilities.

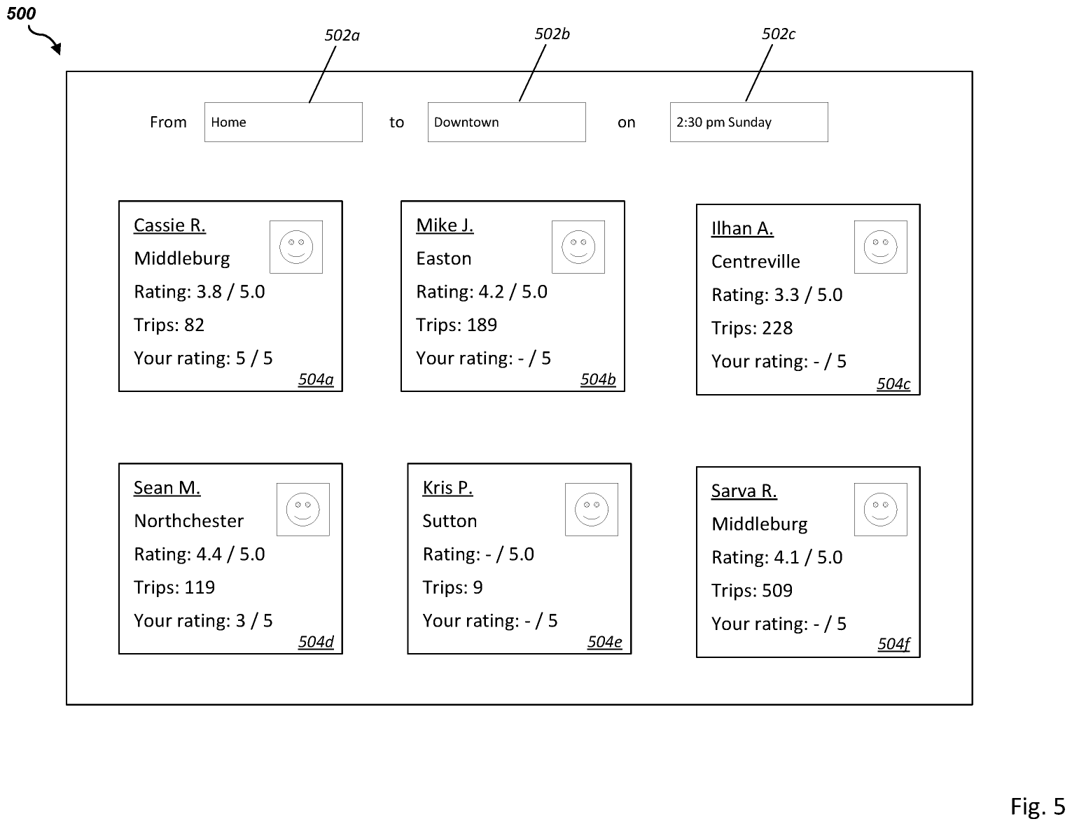

FIG. 5 illustrates a screenshot of an exemplary driver selection screen 500 that may be presented to the owner based on input preferences for a driver. As shown, an owner inputs an origin point 502a, destination point 502b, and the desired time for the trip 502c. Results are provided matching these preferences, as well as either appropriate constraints. Owners (as well as drivers) may have additional limitations, such as the total duration of the trip or the type of vehicle. The system provides those drivers available during the input time, able to travel to the input origin point, and matching any other constraints.

As shown, each profile 504a-f represents a different driver. A picture of each driver is provided, along with the area they are located, their overall rating, and the total number of trips they have previously driven. On the example screen 500, five drivers have ratings between 3.3 and 4.4, with one driver (represented by profile 504e) having only 9 trips, and not yet having enough ratings for an average rating to be listed.

In addition to general ratings, two of the six drivers (represented by profiles 504a and 504d) have ratings given by the owner searching for a driver. In some implementations, each user of the system may be provided with their own history of trips, both those in which they were a driver and those where they were driven by someone else, and their ratings of those trips.

The system may consider any number of factors when determining that a vehicle owner and driver are compatible for engaging in an arrangement in accordance with the present invention. For example, in some implementations, the vehicle owner may put significant restrictions on the use of the vehicle by the driver. The vehicle owner may restrict the driver from picking up passengers in dangerous neighborhoods or under conditions deemed risky to the vehicle. The owner may restrict the total number of miles the driver can put on the vehicle, or how far away from the owner the vehicle can travel. Furthermore, the owner may place restrictions on the vehicle's usage, like not permitting the trunk or another compartment to be opened, not allowing certain seats to be used, or even disallowing use of certain car features such as air conditioning or an audio system. In managing the connection of potential drivers with vehicle owners, the driver can be informed if any of these restrictions are included in the arrangement, and can choose not to accept an arrangement with restrictions the driver finds burdensome.

In contrast, where a vehicle has features that may be appealing to a driver and/or the driver's potential ride share customers, those features can be related to the driver in order to encourage the driver to select a particular owner and vehicle for an arrangement. For example, a vehicle with readily available connections for a child safety seat, or with a rear entertainment system, may be considered a premium ride share vehicle and may even command a premium fare in some cases. By connecting willing drivers with vehicle owners, and presenting each with as much information as is available to make an informed decision about the conditions of the arrangement, each party in the arrangement can receive the full benefit of the struck bargain.

The data structures and code, in which the present disclosure can be implemented, can typically be stored on a non-transitory computer-readable storage medium. The storage can be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the disclosure can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium. Furthermore, the methods and processes described can be included in hardware components. For example, the hardware components can include, but are not limited to, application-specific integrated circuit (ASIC) chips, field-programmable gate arrays (FPGAs), and other programmable-logic devices now known or later developed. When the hardware components are activated, the hardware components perform the methods and processes included within the hardware components.

The technology described herein can be implemented as logical operations and/or components. The logical operations can be implemented as a sequence of processor-implemented executed blocks and as interconnected machine or circuit components. Likewise, the descriptions of various components can be provided in terms of operations executed or effected by the components. The resulting implementation is a matter of choice, dependent on the performance requirements of the underlying system implementing the described technology. Accordingly, the logical operations making up the embodiment of the technology described herein are referred to variously as operations, blocks, objects, or components. It should be understood that logical operations can be performed in any order, unless explicitly claimed otherwise or a specific order is inherently necessitated by the claim language.

Various embodiments of the present disclosure can be programmed using an object-oriented programming language, such as SmallTalk, Java, C++, Ada or C#. Other object-oriented programming languages can also be used. Alternatively, functional, scripting, and/or logical programming languages can be used. Various aspects of this disclosure can be implemented in a non-programmed environment, for example, documents created in HTML, XML, or other format that, when viewed in a window of a browser program, render aspects of a GUI or perform other functions. Various aspects of the disclosure can be implemented as programmed or non-programmed elements, or any combination thereof.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A computer-implemented method comprising:
coordinating with a driver to operate a vehicle having an owner separate from the driver, the operation of the vehicle including first and second rides requested by the owner;
providing authorization for the driver to operate the vehicle for hire by one or more third parties during a time interval between the first and second rides; and
limiting the driver's authorization such that the driver is not authorized to operate the vehicle for hire by one or more third parties during the first or second rides.

2. The method of claim 1, wherein the operation of the vehicle further includes a third ride requested by the owner, and wherein the method further comprises providing authorization for the driver to operate the vehicle for hire by one or more third parties during a time interval between the second and third rides.

3. The method of claim 1, wherein the authorization for the driver to operate the vehicle for hire is geographically limited based on the owner's requested rides.

4. The method of claim 1, further comprising allocating revenue from third party hire of the vehicle to both the driver and the owner.

5. The method of claim 1, further comprising:
during the time interval between the first and second rides, receiving a request from the owner for a third ride to occur during the time interval;
in response to receiving the request for the third ride, restricting the driver's authorization such that the driver is not authorized to operate the vehicle for a third party until the driver has operated the vehicle to carry out the third ride; and
upon completion of the third ride, restoring the driver's authorization for a remainder portion of the time interval.

6. The method of claim 5, wherein the driver is presently carrying out a ride for a third party when the request for the third ride is received, and wherein restricting the driver's authorization does not affect said ride presently carried out.

7. The method of claim 1, further comprising:
receiving a request for a third party ride during the time interval; and
automatically rejecting the request, based on determining that, after carrying out the third party ride, the vehicle would not be able to arrive in time to carry out the second ride.

8. The method of claim 1, wherein the second ride has a destination that is the same as an origin point of the first ride, such that passengers of both the first and second ride return to where they began.
